(19) United States
(12) Patent Application Publication
(10) Pub. No.: US 2020/0362633 A1
(43) Pub. Date: Nov. 19, 2020

(54) SLIDABLE LADDER DEVICE

(71) Applicant: Chia-Ming LIU, Douliou City (TW)

(72) Inventor: Chia-Ming LIU, Douliou City (TW)

(21) Appl. No.: 16/658,538

(22) Filed: Oct. 21, 2019

(30) Foreign Application Priority Data
May 14, 2019 (CN) 201920683449.0

(51) Int. Cl. E06C 9/12

(52) U.S. Cl. CPC E06C 9/12

(57) ABSTRACT

A slidable ladder device is configured to be sleeved on and slidable along a crossbar, and includes two support rods and a plurality of steps connected between the support rods. At least one fixing unit is connected to an end portion of one of the support rods, and includes a base member having a main portion, a connecting portion and an extension portion cooperatively defining an insertion space for insertion of the crossbar therethrough. A switchable member is pivotally connected to the connecting portion, and is rotatable relative to the connecting portion between closed and open positions, in which the switchable member closes and opens an opening of the insertion space, respectively.

### CROSS-REFERENCE TO RELATED APPLICATION

This application claims priority of Chinese Application No. 201920683449.0, filed on May 14, 2019.

### FIELD

The disclosure relates to a ladder, more particularly to a slidable ladder device.

### BACKGROUND

Referring to FIG. 1, a work ladder 13 is usually provided to facilitate a user to place or remove an object 12 to and from a high location of a storage cabinet 11 that is installed in a factory. A conventional work ladder 13 includes two support rods 131 parallel to each other in a top-bottom direction (D), a plurality of parallel steps 132 connected between the support rods 131, and two hook members 133 respectively connected to top ends of the support rods 131.

In use, the hook members 133 are hooked onto a crossbar 111 of the storage cabinet 11, so that the work ladder 13 can be moved along the crossbar 111 to a desired position. However, the work ladder 13 rocks up and down when the user climbs the steps 132 of the work ladder 13, so that the hook members 133 are likely to disengage from the crossbar 111, thereby causing the work ladder 13 to collapse and the user to fall. Thus, there is still room for improvement of the conventional work ladder 13.

### SUMMARY

Therefore, an object of the present disclosure is to provide a slidable ladder device that is safe to use. Accordingly, a slidable ladder device of this disclosure is configured to be sleeved on and slidable along a crossbar of a work cabinet device. The work cabinet device includes a cabinet body, and a plurality of spaced-apart connecting brackets connected between a top end of the cabinet body and the crossbar. The crossbar extends along a horizontal direction. The slidable ladder device includes a ladder frame and at least one fixing unit. The ladder frame includes two support rods extending along a longitudinal direction transverse to the horizontal direction and spaced apart from each other along the horizontal direction, and a plurality of spaced-apart and parallel steps connected between the support rods. Each support rod has a first end portion configured to be proximate to the crossbar, and a second end portion opposite to the first end portion along the longitudinal direction. The at least one fixing unit is connected to the first end portion of one of the support rods, and includes a base member and a switchable member.

The base member is configured to be sleeved on the crossbar, and includes a main portion connected to the first end portion of the one of the support rods, a connecting portion extending from one end of the main portion for partially surrounding the crossbar, and an extension portion extending transversely from the other end of the main portion in a direction away from the one of the support rods and opposite to the connecting portion along the longitudinal direction. The main portion, the connecting portion and the extension portion cooperatively define an insertion space for insertion of the crossbar therethrough. The insertion space has an opening located between a bottom edge of the connecting portion and an outer edge of the extension portion which is distal to the main portion.

The switchable member has a pivot end portion pivotally connected to the connecting portion, and a free end portion opposite to the pivot end portion. The switchable member is rotatable relative to the connecting portion between a closed position, in which the switchable member closes the opening and the free end portion is immediately adjacent to the extension portion, and an open position, in which the free end portion is distal to the extension portion and the opening is opened for permitting passage of a corresponding one of the connecting brackets therethrough.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a conventional work ladder;

FIG. 2 is a perspective view of a slidable ladder device according to an embodiment of the present disclosure;

FIG. 3 is an enlarged fragmentary perspective view of the embodiment, illustrating switchable members of fixing units in a closed position;

FIG. 4 is a view similar to FIG. 3, but illustrating one of the switchable members in an open position;

FIG. 5 is a view similar to FIG. 4, but illustrating the one of the switchable members being pushed by a connecting bracket to pivot; and

FIG. 6 is a view similar to FIG. 3, but illustrating how a crossbar abuts against two extension portions of the fixing units when the embodiment moves upward relative to the crossbar.

### DETAILED DESCRIPTION

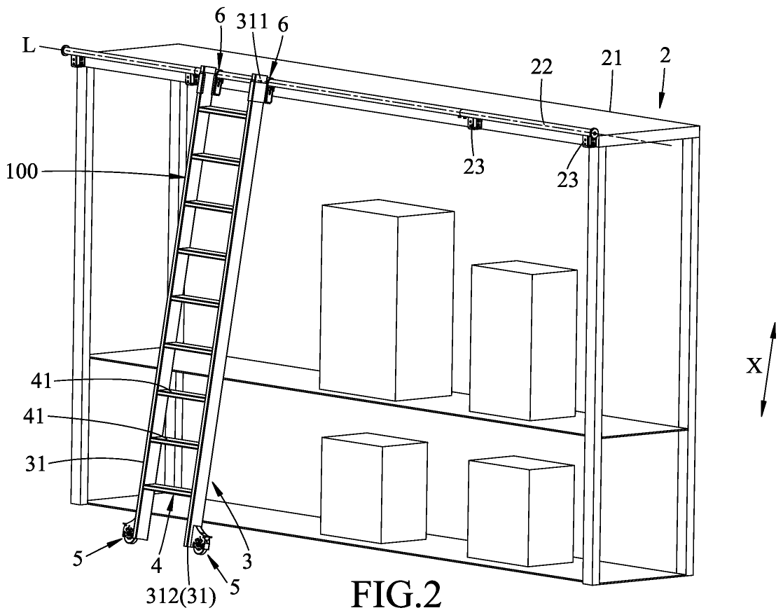

Referring to FIGS. 2 to 4, a slidable ladder device 100 according to an embodiment of the present disclosure is suitable to be mounted to a work cabinet device 2 which includes a cabinet body 21, a crossbar 22 extending along a horizontal direction (L) and disposed on a front side of the cabinet body 21 in proximity to a top surface thereof, and four spaced-apart connecting brackets 23 connected between the cabinet body 21 and the crossbar 22. Each connecting bracket 23 is a U-shaped bracket having two opposite arms 231 and a bight portion 232 between the arms 231.

The slidable ladder device 100 is configured to be sleeved on and slidable along the crossbar 22, and includes a ladder frame 3, two positioning rollers 5, and two fixing units 6.

The ladder frame 3 includes two support rods 31 extending along a longitudinal direction (X) transverse to the horizontal direction (L) and spaced apart from each other along the horizontal direction (L), and a plurality of spaced-apart and parallel steps 41 connected between the support rods 31. Each support rod 31 has a first or top end portion 311 proximate to the crossbar 22, and a second or bottom end portion 312 opposite to the top end portion 311 along the longitudinal direction (X) and adjacent to the ground.

The positioning rollers 5 are respectively connected to the bottom end portions 312 of the support rods 31, and are operated to move the ladder frame 3 to slide or generate positioning.

The fixing units 6 are respectively connected to the top end portions 311 of the support rods 31. Since the structures of the fixing units 6 are the same, only the fixing unit 6 connected to a left side of the support rod 31 shown in FIGS. 2 to 5 will be described hereinafter.

The fixing unit 6 includes a base member 61, a pivot pin 62, and a switchable member 63. The base member 61 is configured to be sleeved on the crossbar 22, and includes a main portion 611, a connecting portion 612 curvedly extending from one end of the main portion 611 for partially surrounding the crossbar 22, and an extension portion 613 extending transversely from the other end of the main portion 611 in a direction away from the support rod 31 and opposite to the connecting portion 612 along the longitudinal direction (X). The main portion 611, the connecting portion 612 and the extension portion 613 cooperatively define an insertion space 64 for extension of the crossbar 22 therethrough. The insertion space 64 has a substantially C-shape with an opening 641 located between a bottom edge of the connecting portion 612 and an outer edge of the extension portion 613 which is distal to the main portion 611. The connecting portion 612 has two stoppers 614 protruding from two opposite lateral edges thereof toward the main portion 611. The stoppers 614 are proximate to the bottom edge of the connecting portion 612.

The base member 61 further includes a fixing bracket 616 connected to the main portion 611 and sleeved on the top end portion 311 of the support rod 31. It should be noted herein that the fixing bracket 616 may be dispensed with in this embodiment. In this case, the main portion 611 is connected directly and fixedly to the top end portion 311 of the support rod 31.

The pivot pin 62 connects the switchable member 63 to an inner surface of the connecting portion 612 in proximity to the bottom edge thereof, and is located below and between the stoppers 614. In this embodiment, the pivot pin 62 is located within the insertion space 64.

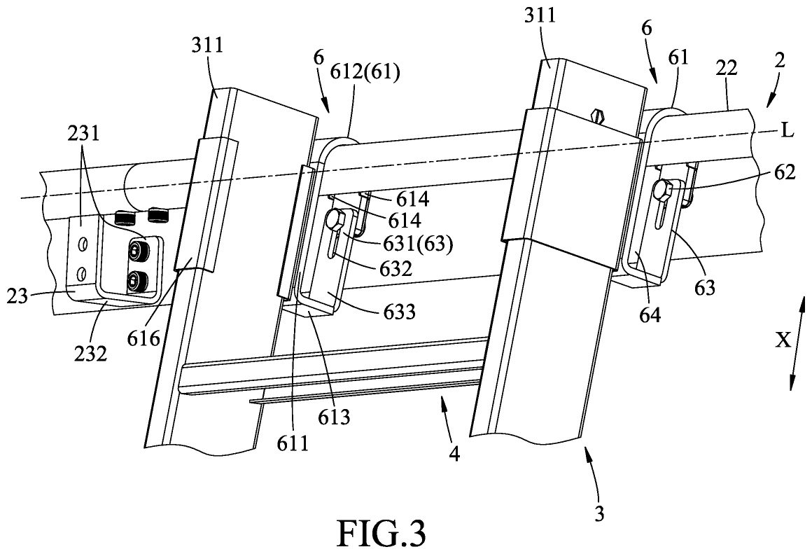

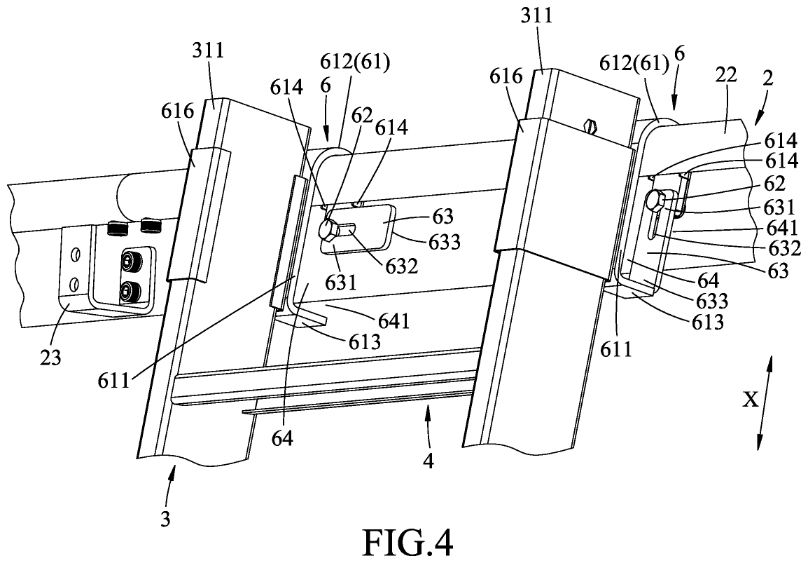

The switchable member 63 of this embodiment is a rectangular plate, and has a pivot end portion 631 pivotally connected to the inner surface of the connecting portion 612 through the pivot pin 62, a pivot hole 632 formed in the pivot end portion 631 for extension of the pivot pin 62 therethrough, and a free end portion 633 opposite to the pivot end portion 631. The switchable member 63 is rotatable relative to the connecting portion 612 about the pivot pin 62 between a closed position and an open position. In the closed position, as shown in FIG. 3, the switchable member 63 closes the opening 641, and the free end portion 633 thereof is immediately adjacent to the extension portion 613. In the open position, as shown in FIG. 4, the free end portion 633 of the switchable member 63 is distal to the extension portion 613, and the opening 641 is opened. A pivoting angle of the switchable member 63 from the closed position to the open position relative to the connecting portion 612 is not greater than 90 degrees. When the switchable member 63 is pivoted to the open position, the switchable member 63 abuts against a corresponding one of the stoppers 614, and the switchable member 63 is prevented from further rotation relative to the connecting portion 612. The switchable member 63 pivots from the open position to the closed position by gravity.

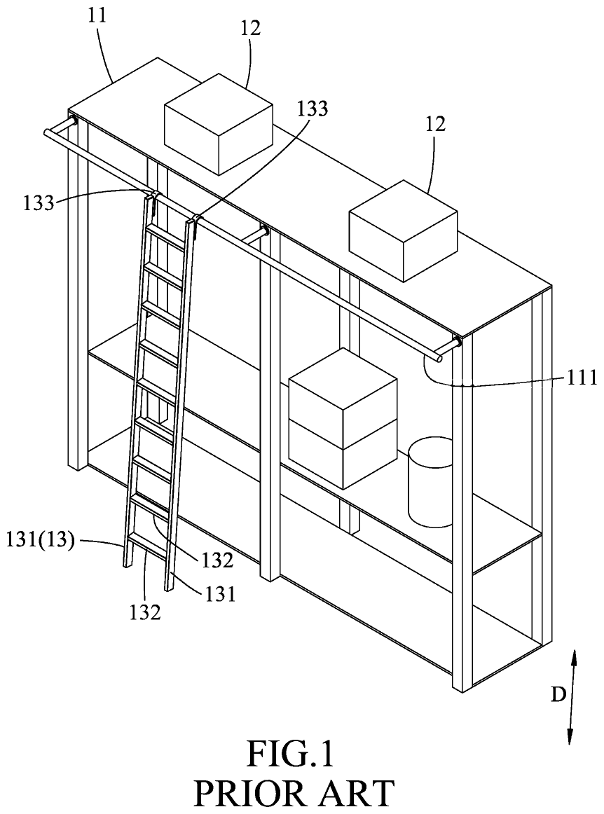

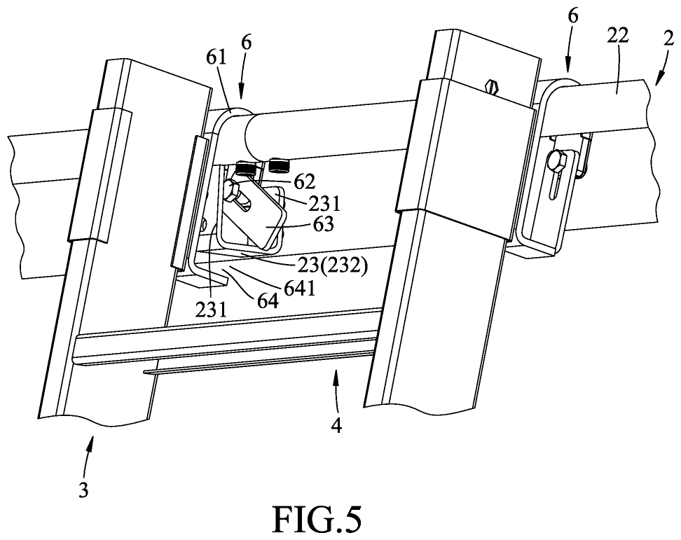

With reference to FIGS. 1 and 5, to mount the slidable ladder device 100 of this disclosure to the crossbar 22, the base members 61 of the fixing units 6 connected to the left and right support rods 31 of the ladder frame 3 are sleeved on the right end of the crossbar 22 one after the other with the crossbar 22 extending through the insertion spaces 64 of the base members 61. As the switchable member 63 of the fixing unit 6 connected to the left support rod 31 contacts the bight portion 232 of the connecting bracket 23 on the right end of the crossbar 22, the switchable member 63 is pushed by the bight portion 232 to pivot upward relative to the connecting portion 612, so that the connecting bracket 23 can pass through the insertion space 64, and the base member 61 can slide leftward along the crossbar 22. The same is true for the switchable member 63 of the fixing unit 6 connected to the right support rod 31. After the base members 61 of the fixing units 6 connected to the left and right support rods 31 are sleeved on the crossbar 22, the fixing units 6 together with the ladder frame 3 can slide leftward and rightward along the crossbar 22.

It should be noted herein that the base members 61 of the fixing units 6 may also be sleeved on the left end of the crossbar 22 one after the other with the crossbar 22 extending through the insertion spaces 64 of the base members 61. The switchable members 63 of the fixing units 6 connected to the left and right support rods 31 may similarly be pushed by the bight portion 232 of the connecting bracket 23 on the left end of the crossbar 22 so as to pivot upward relative to the connecting portions 612, so that the connecting bracket 23 may pass through the insertion space 64, and the fixing units 6 together with the ladder frame 3 may slide rightward and leftward along the crossbar 22.

Another method for mounting the slidable ladder device 100 of this disclosure to the crossbar 22 is for the user to pivot the switchable members 63 to the open positions firstly, after which the connecting portions 612 of the base members 61 are hooked onto the crossbar 22 such that the crossbar 22 is received in the insertion spaces 64 of the base members 61 through the openings 641. Then, the user releases the switchable members 63 which move to the closed positions by gravity.

After the ladder frame 3 of the slidable ladder device 100 is slid along the crossbar 22 to a predetermined position, the positioning rollers 5 are operated to position the support rods 31. The slidable ladder device 100 is now ready for use.

Taking as an example the fixing unit 6 on the left side of FIG. 5, when the fixing unit 6 is moved from a right side to a left side of the connecting bracket 23, a left side of the switchable member 63 is pushed by the bight portion 232 of the connecting bracket 23 to pivot upward in a counterclockwise direction relative to the connecting portion 612 about the pivot pin 62 as the base member 61 is continuously moved toward a left side of the crossbar 22. As such, the opening 641 of the insertion space 64 is gradually opened, and the connecting bracket 23 can pass through the insertion space 64 through the opening 641. After the connecting bracket 23 passes through the insertion space 64, the switchable member 63 will pivot downward in a clockwise direction relative to the connecting portion 612 to the closed position by gravity.

Furthermore, apart from being able to pivot upward in the counterclockwise direction relative to the connecting portion 612 of the base member 61, as shown in FIG. 5, the switchable member 63 may also be pivoted upward in a clockwise direction relative to the connecting portion 612 so as to move from the left side to the right side of the connecting bracket 23.

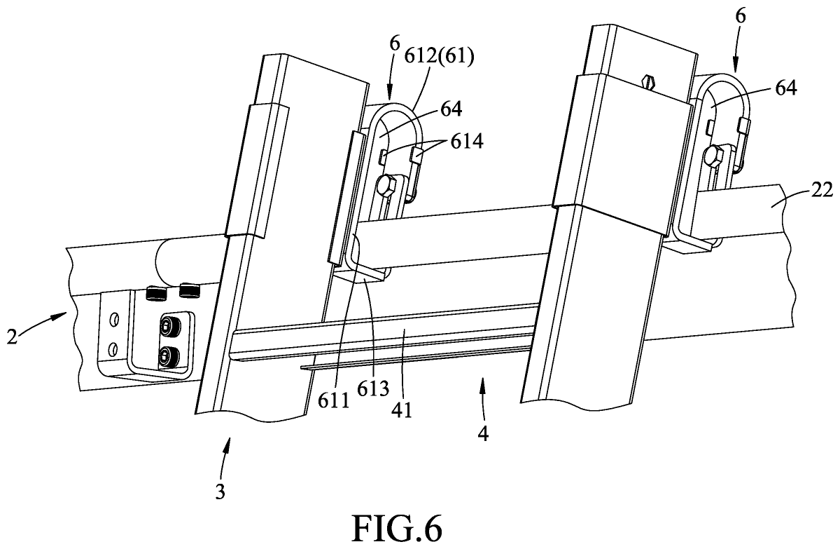

Referring to FIG. 6, in addition, when the user climbs up and down the steps 41 of the ladder frame 3 of the slidable ladder device 100, the slidable ladder device 100 may rock up and down. But, since the crossbar 22 is inserted into the insertion space 64 and the switchable member 63 closes the opening 641 of the insertion space 64, the above rocking situation will not cause the fixing units 6 to disengage from the crossbar 22 because the crossbar 22 will only move up and down within the insertion space 64, so that safety of the slidable ladder device 100 in use can be enhanced. Thus, through the provision of the fixing units 6, the slidable ladder device 100 can slide along the length of the crossbar 22 without being hindered by the connecting brackets 23 of the work cabinet device 2. Further, the fixing units 6 will not disengage from the crossbar 22 caused by the up and down rocking of the slidable ladder device 100 during use thereof, so that safe use of the slidable ladder device 100 can be effectively enhanced.

It is worth to mention herein that, in this embodiment, the slidable ladder device 100 includes two fixing units 6. However, in other embodiments, the slidable ladder device 100 may include only one fixing unit 6 connected to the top end portion 311 of one of the support rods 31. The effects as described above may be similarly achieved.

It should be particularly noted herein that, in this embodiment, the pivot pin 62 of each fixing unit 6 is connected to the inner surface of the connecting portion 612, and the switchable member 63 of each fixing unit 6 is connected to the inner surface of the connecting portion 612 through the pivot pin 62. However, in other embodiments, the pivot pin 62 of each fixing unit 6 may be connected to an outer surface of the connecting portion 612, and the switchable member 63 of each fixing unit 6 is connected to the outer surface of the connecting portion 612 through the pivot pin 62. As long as the switchable member 63 of each fixing unit 6 can be pivotally connected to the connecting portion 612 of a respective one of the base members 61 through the pivot pin 62 to openably cover the opening 641 of the insertion space 64, any disposition of the switchable member 63 is acceptable.

Moreover, in this embodiment, the connecting portion 612 of each fixing unit 6 is provided with the stoppers 614 on left and right lateral edges thereof that protrude toward the main portion 611, as best shown in FIG. 6. However, in other embodiments, the stoppers 614 may be provided on the left and right lateral edges of the connecting portion 612 that protrude away from the main portion 611; or, the connecting portion 612 of each fixing unit 6 may be provided with only one stopper 614 on the inner surface thereof that extend between the left and right lateral edges thereof. As long as the switchable member 63 of each fixing unit 6 can abut against the stopper 614 during its transition from the closed position to the open position to stop its continuous rotation, any position of the stopper 614 is acceptable.

It is worth to mention herein that, in this embodiment, the pivoting angle of the switchable member 63 of each fixing unit 6 relative to the connecting portion 612 of a respective one of the base members 61 is not greater than 90 degrees. However, in other embodiments, the pivoting angle of the switchable member 63 of each fixing unit 6 may be greater than 90 degrees. As long as the connecting bracket 23 can pass through the insertion space 64 when the switchable member 63 is pivoted to the open position, and the switchable member 63 can pivot back to the closed position by gravity after the connecting bracket 23 passes through the insertion space 64, any pivoting angle of the switchable member 63 is acceptable.

In summary, through the base members 61 and the switchable members 63 of the fixing units 6, when the switchable members 63 of the fixing units 6 are in the closed positions, the crossbar 22 can be inserted through the insertion spaces 64 of the base members 61 of the fixing units 6, so that when the slidable ladder device 100 of this disclosure rocks during climbing of the steps 41 of the ladder frame 3 by the user, the fixing units 6 cannot be easily disengaged from the crossbar 22. Hence, collapsing of the slidable ladder device 100 can be prevented, thereby enhancing the safe use of the slidable ladder device 100. Further, because each connecting bracket 23 can push the switchable member 63 of each fixing unit 6 to pivot from the closed position to the open position and can pass through the insertion space 64, the slidable ladder device 100 can slide smoothly along the crossbar 22 without being hindered by the connecting brackets 23 of the work cabinet device 2. Therefore, the object of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A slidable ladder device configured to be sleeved on and slidable along a crossbar of a work cabinet device, the work cabinet device including a cabinet body, and a plurality of spaced-apart connecting brackets connected between a top end of the cabinet body and the crossbar, the crossbar extending along a horizontal direction, said slidable ladder device comprising:
a ladder frame including two support rods extending along a longitudinal direction transverse to the horizontal direction and spaced apart from each other along the horizontal direction, and a plurality of spaced-apart and parallel steps connected between said support rods, each of said support rods having a first end portion configured to be proximate to the crossbar, and a second end portion opposite to said first end portion along the longitudinal direction; and
at least one fixing unit connected to said first end portion of one of said support rods and including
a base member configured to be sleeved on the crossbar and including a main portion connected to said first end portion of said one of said support rods, a connecting portion extending from one end of said main portion for partially surrounding the crossbar, and an extension portion extending transversely from the other end of said main portion in a direction away from said one of said support rods and opposite to said connecting portion along the longitudinal direction, wherein said main portion, said connecting portion and said extension portion cooperatively define an insertion space for insertion of the crossbar therethrough, said insertion space having an opening located between a bottom edge of said connecting portion and an outer edge of said extension portion which is distal to said main portion; and
a switchable member having a pivot end portion pivotally connected to said connecting portion, and a free end portion opposite to said pivot end portion, said switchable member being rotatable relative to said connecting portion between a closed position, in which said switchable member closes said opening and said free end portion is immediately adjacent to said extension portion, and an open position, in which said free end portion is distal to said extension portion and said opening is opened for permitting passage of a corresponding one of the connecting brackets therethrough.

2. The slidable ladder device as claimed in claim 1, wherein said at least one fixing unit further includes a pivot pin connecting said switchable member to said connecting portion, and said switchable member further has a pivot hole formed in said pivot end portion for extension of said pivot pin therethrough.

3. The slidable ladder device as claimed in claim 2, wherein said connecting portion has two stoppers provided on two opposite lateral edges thereof, and said switchable member is abuttable against one of said stoppers to stop continuous rotation of said switchable member when pivoted to said open position.

4. The slidable ladder device as claimed in claim 3, wherein a pivoting angle of said switchable member relative to said connecting portion is not greater than 90 degrees.

5. The slidable ladder device as claimed in claim 1, further comprising two positioning rollers respectively connected to said second end portion portions of said support rods.

6. The slidable ladder device as claimed in claim 1, wherein said base member further includes a fixing bracket connected to said main portion and sleeved on said first end portion of said one of said support rods.
